(19) United States
(12) Patent Application Publication
(10) Pub. No.: US 2024/0257231 A1
(43) Pub. Date: Aug. 1, 2024

(54) TECHNOLOGY TO ENHANCE ACCOUNT STATUS LEVELING

(71) Applicant: Truist Bank, Charlotte, NC (US)

(72) Inventors: Hope Astle, Charlotte, NC (US); Kristen Martin, Charlotte, NC (US); Adam Rogers, Charlotte, NC (US); Erik Schutzman, Charlotte, NC (US); Sarah Massagee, Charlotte, NC (US); Joel Baker, Charlotte, NC (US); Federico Scholcover, Charlotte, NC (US)

(21) Appl. No.: 18/159,737

(22) Filed: Jan. 26, 2023

(51) Int. Cl. G06Q 40/02; G06Q 20/10

(52) U.S. Cl. CPC G06Q 40/02; G06Q 20/108; G06F 3/0483

(57) ABSTRACT

Systems, apparatuses, and computer-implemented methods provide for technology that identifies a current status level of an account based on an aggregate balance associated with an individual corresponding to the account, generates a GUI. The GUI includes an indication of a plurality of status levels, an indication of the current status level, an unlocked indicator for status levels below the current status level, and a locked indicator for status levels above the current status level, and causes display of the GUI on a user interface of a client device associated with the individual.

### TECHNICAL FIELD

Embodiments generally relate to graphical user interfaces (GUIs). More particularly, embodiments relate to GUI technology to enhance account status leveling.

### BACKGROUND

Graphical user interfaces (GUIs) are used in a wide variety of settings to facilitate online communications. In a software application associated with a financial institution, for example, an account user may use a GUI to manage accounts, conduct transactions, and so forth. Conventional financial institution GUIs, however, may be inadequate in terms of fee transparency from the perspective of the account owner and/or inefficient in terms of customer loyalty from the perspective of the financial institution.

### SUMMARY

In one embodiment, a computing system comprises a network controller, a processor coupled to the network controller, and a memory coupled to the processor, wherein the memory includes a set of instructions, which when executed by the processor, cause the processor to identify a current status level of an account based on an aggregate balance associated with an individual corresponding to the account, generate a graphical user interface (GUI), wherein the GUI includes an indication of a plurality of status levels, an indication of the current status level, an unlocked indicator for status levels below the current status level, and a locked indicator for status levels above the current status level, wherein the indication of the plurality of status levels includes a description of each of the plurality of status levels, incorporate a level up option into the GUI, incorporate an alert preferences page into the GUI, wherein the alert preferences page includes a level up alert option and a level down alert option, detect an increase in the current status level, incorporate a confetti-based animation into the GUI in response to the increase in the current status level, and send, via the network controller, the GUI to a client device associated with the individual for display on a user interface of the client device.

In another embodiment, a computing system comprises a network controller, a processor coupled to the network controller, and a memory coupled to the processor, wherein the memory includes a set of instructions, which when executed by the processor, cause the processor to identify a current status level of an account based on an aggregate balance associated with an individual corresponding to the account, generate a graphical user interface (GUI), wherein the GUI includes an indication of a plurality of status levels, an indication of the current status level, an unlocked indicator for status levels below the current status level, and a locked indicator for status levels above the current status level, and send, via the network controller, the GUI to a client device associated with the individual.

In another embodiment, at least one computer readable storage medium comprises a set of instructions, which when executed by a computing system, cause the computing system to identify a current status level of an account based on an aggregate balance associated with an individual corresponding to the account, generate a graphical user interface (GUI), wherein the GUI includes an indication of a plurality of status levels, an indication of the current status level, an unlocked indicator for status levels below the current status level, and a locked indicator for status levels above the current status level, and send, via the network controller, the GUI to a client device associated with the individual for display on a user interface of the client device.

### DRAWINGS

The various advantages of the exemplary embodiments will become apparent to one skilled in the art by reading the following specification and appended claims, and by referencing the following drawings, in which:

FIG. 1 illustrates a communication environment in accordance with one or more embodiments set forth and described herein;

FIG. 2 illustrates a block diagram of the mobile device of FIG. 1;

FIG. 3 illustrates a block diagram of the personal computing device of FIG. 1;

FIG. 4 illustrates a block diagram of the one or more financial institution servers of FIG. 1;

FIG. 5 is an illustration of an example of a graphical user interface (GUI) that includes an indication of a plurality of status levels and an unlocked indicator according to an embodiment;

FIG. 6 is an illustration of an example of a GUI that includes an indication of a plurality of status levels and an indication of a current status level according to an embodiment;

FIGS. 7-8 are illustrations of an example of a GUI that includes an indication of a plurality of status levels and a locked indicator according to an embodiment;

FIG. 9 is an illustration of an example of a GUI that includes an indication of a plurality of status levels and an indication of a current status level according to another embodiment;

FIG. 10A is an illustration of an example of a level up option landing page according to an embodiment;

FIG. 10B is an illustration of an example of an overdraft management option landing page according to an embodiment;

FIGS. 11A-11E are illustrations of examples of a GUI that includes an indication of a plurality of status levels spread across a corresponding plurality of scrollable pages according to an embodiment;

FIG. 12A is an illustration of an example of an overdraft management option landing page according to another embodiment;

FIG. 12B is an illustration of an example of a level up option landing page according to another embodiment;

FIGS. 13A-13B are illustrations of examples of a GUI that includes a confetti-based animation according to an embodiment;

FIG. 14 is an illustration of an example of a GUI that includes a confetti-based animation according to another embodiment;

FIG. 15 is an illustration of an example of a GUI that includes an alert preferences page according to an embodiment;

FIG. 16 is a flowchart of an example of a computer-implemented method of operating a performance-enhanced computing system according to an embodiment;

FIG. 17 is a flowchart of an example of a computer-implemented method of handling a level up event according to an embodiment;

FIG. 18 is a flowchart of an example of a computer-implemented method of generating a GUI according to an embodiment;

FIG. 19 is a flowchart of an example of a computer-implemented method of handling a direct deposit condition according to an embodiment;

FIG. 20A is a block diagram of an example of a server according to an embodiment; and

FIG. 20B is a block diagram of an example of a client device according to an embodiment.

### DETAILED DESCRIPTION

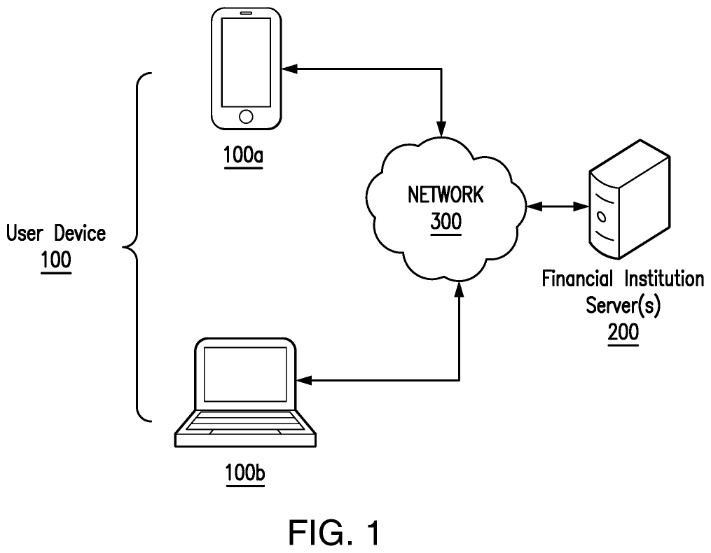

Turning to the figures, in which FIG. 1 illustrates a communication environment in which a user communicates with a financial institution. A user device 100 (100a, 100b) operating in the communication environment facilitates user access to and user management of one or more user accounts residing at one or more financial institution servers 200 of the financial institution. The communication environment includes the user device 100, the one or more financial institution servers 200, and a communications network 300 through which communication is facilitated between the user device 100 and the one or more financial institution servers 200.

In accordance with one or more embodiments, the user device 100 comprises a computing device, including but not limited to a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the user device 100 comprising any form of electronic device that optimizes the performance and functionality of the one or more embodiments in fa manner that falls within the spirit and scope of the principles of this disclosure.

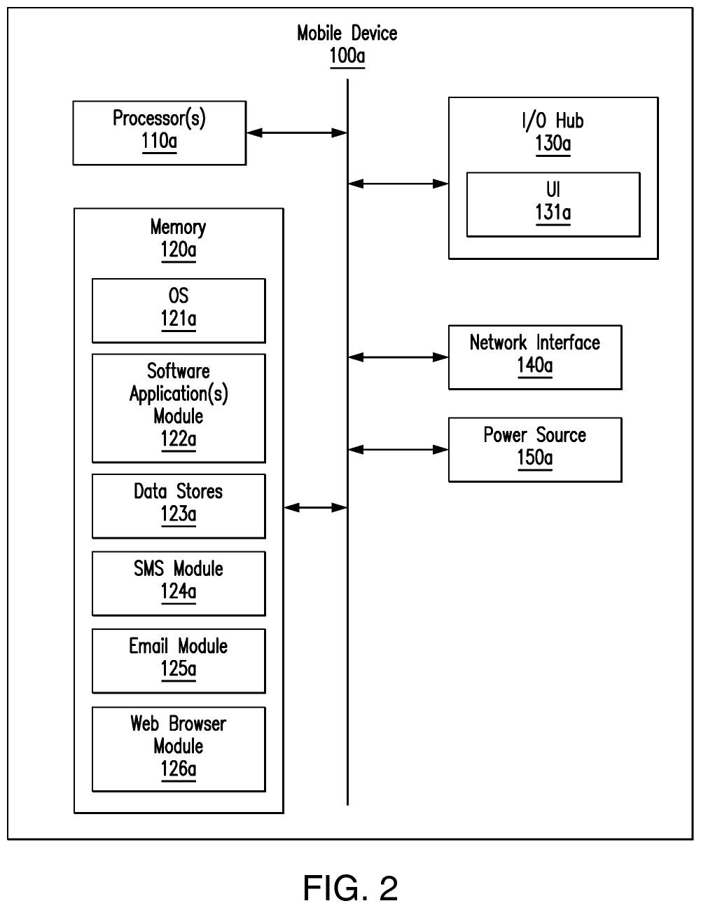

In the illustrated example embodiment of FIG. 2, the user device 100 (FIG. 1) comprises a mobile device 100a. Some of the possible operational elements of the mobile device 100a are illustrated in FIG. 2 and will now be described herein. It will be understood that it is not necessary for the mobile device 100a to have all the elements illustrated in FIG. 2. For example, the mobile device 100a may have any combination of the various elements illustrated in FIG. 2. Moreover, the mobile device 100a may have additional elements to those illustrated in FIG. 2.

The mobile device 100a includes one or more processors 110a, a non-transitory memory 120a operatively coupled to the one or more processors 110a, an I/O hub 130a, a network interface 140a, and a power source 150a.

The memory 120a comprises a set of instructions of computer-executable program code. The set of instructions are executable by the one or more processors 110a to cause the one or more processors 110a to execute an operating system 121a and one or more software applications of a software application module 122a that reside in the memory 120a. The one or more software applications residing in the memory 120a includes, but is not limited to, a financial institution application that is associated with the financial institution servers 200 (FIG. 1) and which facilitates user access to the one or more user accounts in addition to user management of the one or more user accounts. The financial institution application comprises a mobile financial institution application that facilitates establishment of a secure connection between the mobile device 100a and the one or more financial institution servers 200 (FIG. 1).

The memory 120a also includes one or more data stores 123a that are operable to store one or more types of data. The mobile device 100a may include one or more interfaces that facilitate one or more systems or modules thereof to transform, manage, retrieve, modify, add, or delete, the data residing in the data stores 123a. The one or more data stores 123a may comprise volatile and/or non-volatile memory. Examples of suitable data stores 123a include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 123a may be a component of the one or more processors 110a, or alternatively, may be operatively connected to the one or more processors 110a for use thereby. As set forth, described, and/or illustrated herein, “operatively connected” may include direct or indirect connections, including connections without direct physical contact.

The memory 120a also includes an SMS (short messaging service) module 124a operable to facilitate user transmission and receipt of text messages via the mobile device 100a though the network 300 (FIG. 1). In one example embodiment, a user may receive text messages from the financial institution that are associated with the user access and the user management of the one or more user accounts. An email module 125a is operable to facilitate user transmission and receipt of email messages via the mobile device 100a through the network 300 (FIG. 1). In one example embodiment, a user may receive email messages from the financial institution that are associated with the user access and the user management of the one or more user accounts. A user may utilize a web browser module 126a that is operable to facilitate user access to one or more websites associated with the financial institution through the network 300 (FIG. 1).

In accordance with one or more embodiments, the mobile device 100a includes an I/O hub 130a operatively connected to other systems and subsystems of the mobile device 100a. The I/O hub 130a may include one or more of an input interface, an output interface, and a network controller to facilitate communications between the user device 100 and the server 200 (FIG. 1). The input interface and the output interface may be integrated as a single, unitary user interface 131a, or alternatively, be separate as independent interfaces that are operatively connected.

As used herein, the input interface is defined as any device, software, component, system, element, or arrangement or groups thereof that enable information and/or data to be entered as input commands by a user in a manner that directs the one or more processors 110a to execute instructions. The input interface may comprise a user interface (UI), a graphical user interface (GUI), such as, for example, a display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may comprise one or more of a visual display or an audio display, including, but not limited to, a microphone, earphone, and/or speaker. One or more components of the mobile device 100a may serve as both a component of the input interface and a component of the output interface.

The mobile device 100a includes a network interface 140a operable to facilitate connection to the network 300. The mobile device 100a also includes a power source 150a that comprises a wired powered source, a wireless power source, a replaceable battery source, or a rechargeable battery source.

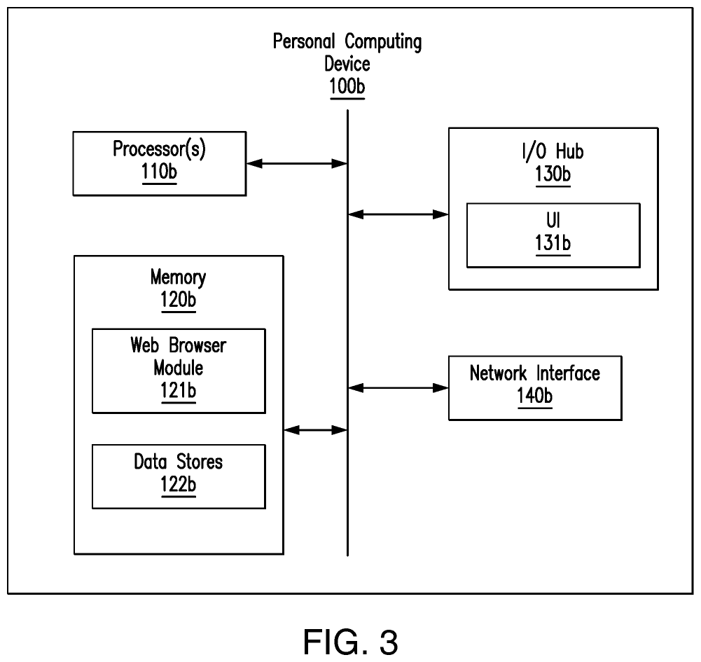

In the illustrated example embodiment of FIG. 3, the user device 100 (FIG. 1) comprises a personal computing device 100b. Some of the possible operational elements of the personal computing device 100b are illustrated in FIG. 3 and will now be described herein. It will be understood that it is not necessary for the personal computing device 100b to have all the elements illustrated in FIG. 3. For example, the personal computing device 100b may have any combination of the various elements illustrated in FIG. 3. Moreover, the personal computing device 100b may have additional elements to those illustrated in FIG. 3.

The personal computing device 100b includes one or more processors 110b, a non-transitory memory 120b operatively coupled to the one or more processors 110b, an I/O hub 130b, and a network interface 140b. The I/O hub 130b may include one or more of an input interface, an output interface, and a network controller to facilitate communications between the user device 100 and the server 200 (FIG. 2). The input interface and the output interface may be integrated as a single, unitary user interface 131b, or alternatively, be separate as independent interfaces that are operatively connected.

The memory 120b comprises a set of instructions of computer-executable program code. The set of instructions are executable by the one or more processors 110b to cause the one or more processors 110b to control the web browser module 121b in a manner that facilitates user access to a web browser having one or more websites associated with the financial institution through the network 300.

The memory 120b also includes one or more data stores 122b that are operable to store one or more types of data. The personal computing device 100b may include one or more interfaces that facilitate one or more systems or modules thereof to transform, manage, retrieve, modify, add, or delete, the data residing in the data stores 122b. The one or more data stores 122a may comprise volatile and/or non-volatile memory. Examples of suitable data stores 122b include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 122b may be a component of the one or more processors 110b, or alternatively, may be operatively connected to the one or more processors 110b for use thereby. As set forth, described, and/or illustrated herein, “operatively connected” may include direct or indirect connections, including connections without direct physical contact.

In accordance with one or more embodiments set forth, described, and/or illustrated herein, “processor” means any component or group of components that are operable to execute any of the processes described herein or any form of instructions to carry out such processes or cause such processes to be performed. The one or more processors 110a (FIG. 2), 110b may be implemented with one or more general-purpose and/or one or more special-purpose processors. Examples of suitable processors include graphics processors, microprocessors, microcontrollers, DSP processors, and other circuitry that may execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The one or more processors 110a (FIG. 2), 110b may comprise at least one hardware circuit (e.g., an integrated circuit) operable to carry out instructions contained in program code. In embodiments in which there is a plurality of processors, such processors may work independently from each other, or one or more processors may work in combination with each other.

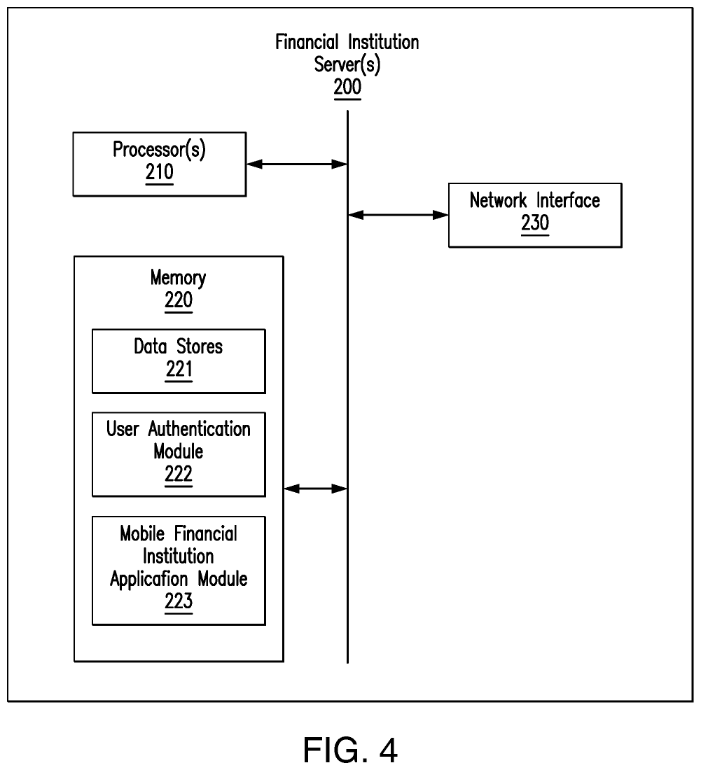

As illustrated in FIG. 4, the one or more financial institution servers 200 includes one or more processors 210, a non-transitory memory 220 operatively coupled to the one or more processors 210, and a network interface 230. Some of the possible operational elements of each server in the one or more financial institution servers 200 are illustrated in FIG. 4 and will now be described herein. It will be understood that it is not necessary for each server in the one or more financial institution servers 200 to have all the elements illustrated in FIG. 4. For example, each server in the one or more financial institution servers 200 may have any combination of the various elements illustrated in FIG. 4. Moreover, each server in the one or more financial institution servers 200 may have additional elements to those illustrated in FIG. 4.

The memory 220 comprises a set of instructions of computer-executable program code. The set of instructions are executable by the one or more processors 210 in manner that facilitates control of a user authentication module 222 and a mobile financial institution application module 223 having one or more mobile financial institution applications that reside in the memory 220.

The memory 220 also includes one or more data stores 221 that are operable to store one or more types of data, including but not limited to, user account data and user authentication data. The one or more data stores 221 may comprise volatile and/or non-volatile memory. Examples of suitable data stores 221 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 221 may be a component of the one or more processors 210, or alternatively, may be operatively connected to the one or more processors 210 for use thereby. As set forth, described, and/or illustrated herein, “operatively connected” may include direct or indirect connections, including connections without direct physical contact.

The computer-executable program code may instruct the one or more processors 210 to cause the user authentication module 221 to authenticate a user in order to gain user access to the one or more user accounts. The user authentication module 221 may be caused to request user input user data or user identification that include, but are not limited to, user identity (e.g., user name), a user passcode, a cookie, user biometric data, a private key, a token, and/or another suitable authentication data or information.

The computer-executable program code of the one or more mobile financial institution applications of the mobile financial institution application module 222 may instruct the one or more processors 210 to execute certain logic, data-processing, and data-storing functions of the one or more financial institution servers 200, in addition to certain communication functions of the one or more financial institution servers 200. The one or more mobile financial institution applications of the mobile financial institution application module 222 are operable to communicate with the user device 100 (FIG. 1) in a manner which facilitates user access to the one or more user accounts in addition to user management of the one or more user accounts based on successful user authentication.

In accordance with one or more embodiments set forth, described, and/or illustrated herein, the network 300 (FIG. 1) may comprise a wireless network, a wired network, or any suitable combination thereof. For example, the network 300 (FIG. 1) is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

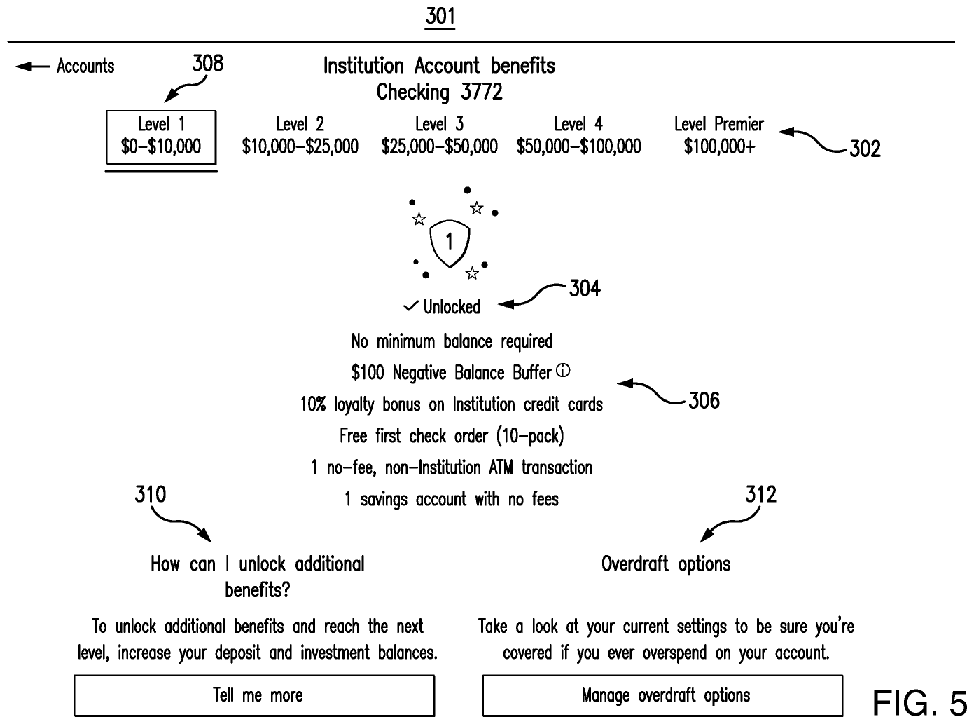

Turning now to FIG. 5, a single graphical user interface (GUI) page 301 is shown. The GUI page 301 may generally be generated by a server such as, for example, the financial institution server(s) 200 (FIGS. 1 and 4) and sent to a browser on a client device such as, for example, the user device 100 (FIG. 1), the mobile device 100a (FIGS. 1 and 2) and/or the personal computing device 100b (FIGS. 1 and 3), already discussed, for presentation to an individual (e.g., owner, user) corresponding an account (e.g., checking account). In the illustrated example, the GUI page 301 includes an indication of a plurality of status levels 302 (e.g., Level 1, Level 2, . . . Level Premier), an unlocked indicator 304, and a description 306 of a selected level 308. The unlocked indicator 304 is incorporated into the GUI page 301 when the selected level 308 is below a current status level of the account in question. The GUI page 301 may also include a level up option 310 and an overdraft management option 312, which will be discussed in greater detail.

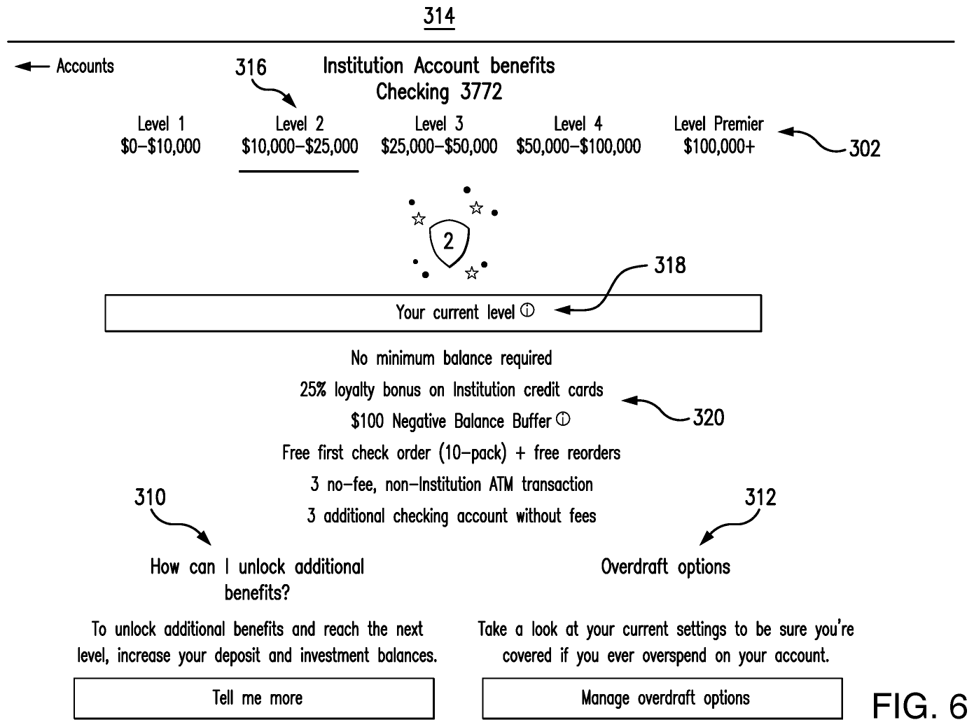

FIG. 6 shows a GUI page 314 in which a selected level 316 is the current status level as reflected in an indication 318 of the current status level. Again, the GUI page 314 also includes a description 320 of the selected level 316.

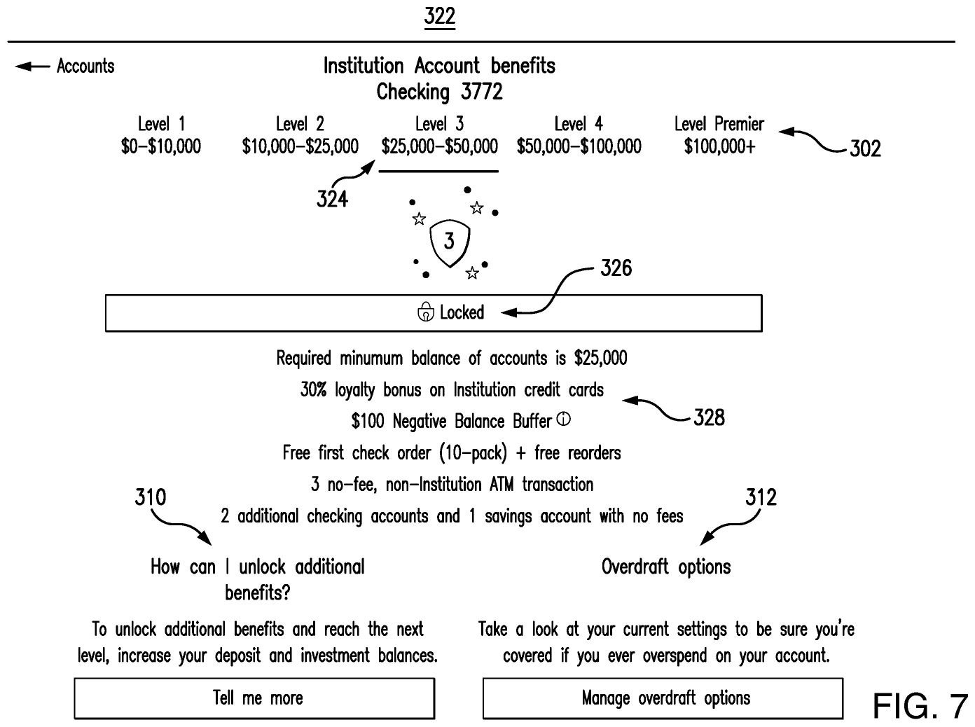

FIG. 7 shows a GUI page 322 in which a selected level 324 is above the current status level of the account in question. Accordingly, the GUI page 322 also includes a locked indicator 326 to reflect that the individual does not yet have access to the benefits indicated in a description 328 of the selected level 324.

Similarly, FIG. 8 shows a GUI page 330 in which a selected level 332 is above the current status level of the account in question. The GUI page 330 therefore includes the locked indicator 326 to reflect that the individual does not yet have access to the benefits indicated in a description 334 of the selected level 332.

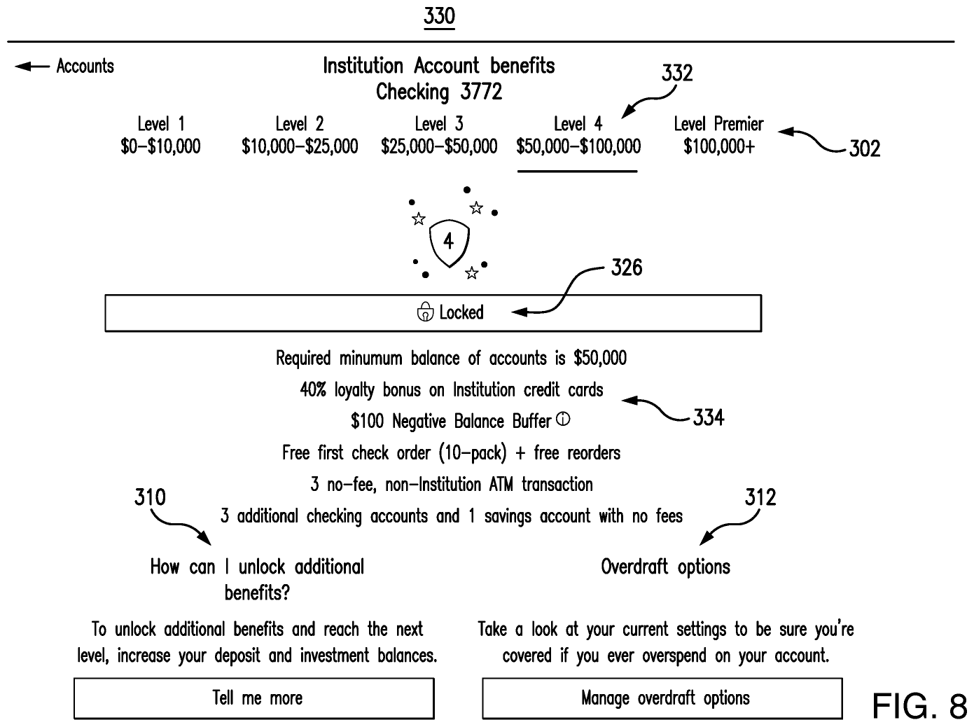

FIG. 9 shows a GUI page 336 in which a selected level 338 is the current status level of the account in question as reflected in the indication 318 of the current status level. In the illustrated example, the current status level is the highest level in the plurality of status levels 302. Accordingly, the GUI page 336 may also include a star-based indicator 340 (e.g., to acknowledge the substantial loyalty of the individual to the financial institution). In an embodiment, the GUI page 336 also includes a description 342 of the selected level 338.

The GUI pages 301, 314, 322, 330, 336 (FIGS. 5-9) therefore enhance the performance of the server in terms of fee transparency (e.g., from the perspective of the account owner) and/or the efficiency of the server in terms of customer loyalty (e.g., from the perspective of the financial institution). For example, presenting the plurality status levels 302 in the GUI pages 301, 314, 322, 330, 336 (FIGS. 5-9) enables the account owner to seamlessly determine the fee and benefit structure of each status level, as well as the requirements for gaining access to each status level. Moreover, incorporating the level up option 310 into the GUI pages 301, 314, 322, 330 (FIGS. 5-8) makes the server more efficient in increasing customer loyalty (e.g., aggregate deposits).

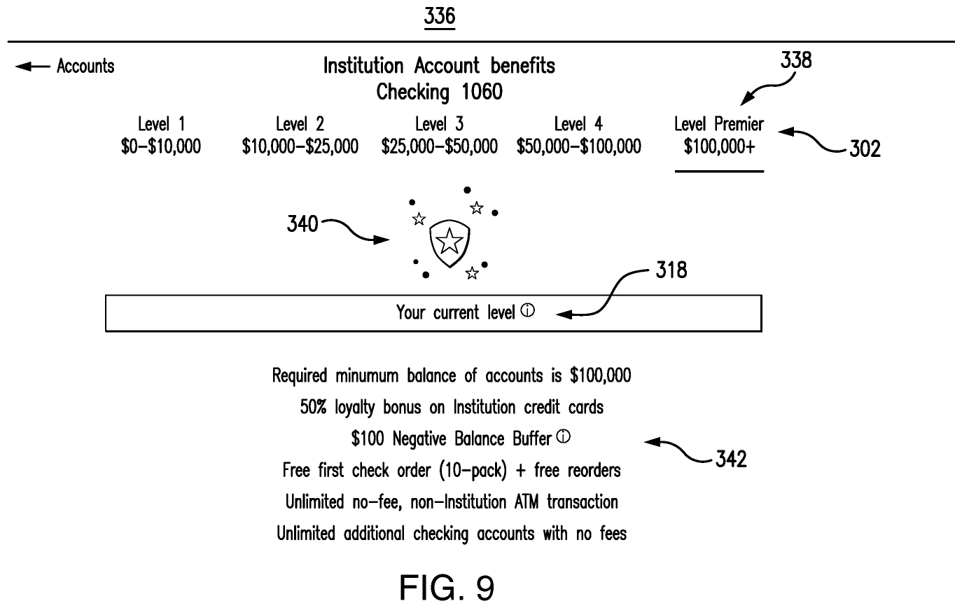

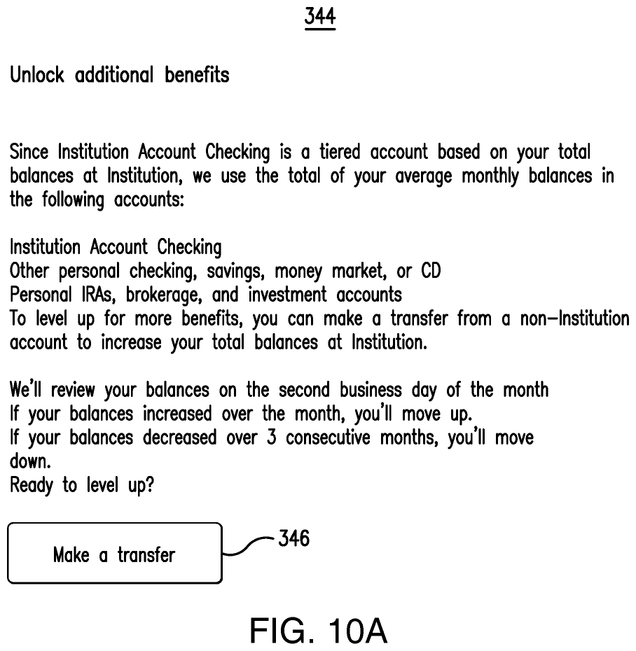

FIG. 10A shows a landing page 344 that may be presented to the account owner when the level up option 310 (FIGS. 5-8) is selected. In the illustrated example, the landing page 344 includes an explanation of how an aggregate balance is used to increase the status level of (e.g., level up) the account, as well as a transfer option 346 to initiate the level up.

FIG. 10B shows a landing page 348 that may be presented to the account owner when the overdraft management option 312 (FIGS. 5-8) is selected. In the illustrated example, the landing page 348 indicates the overdraft status of the account in question and provides the ability to enroll in overdraft protection. In an embodiment, the landing page 348 also includes a description 350 of a negative balance buffer option. For example, a detail option 352 might indicate that when a direct deposit condition (e.g., account has been open for thirty-five days and a direct deposit of at least 100USD/United States Dollars has been made for two consecutive months, as long as the account is in good standing) is detected with respect to the account, a negative balance will be permitted in response to the direct deposit condition, wherein the negative balance will be automatically repaid from a subsequent direct deposit. Thus, the description 350 of the negative balance buffer option further increases fee transparency and improves customer loyalty.

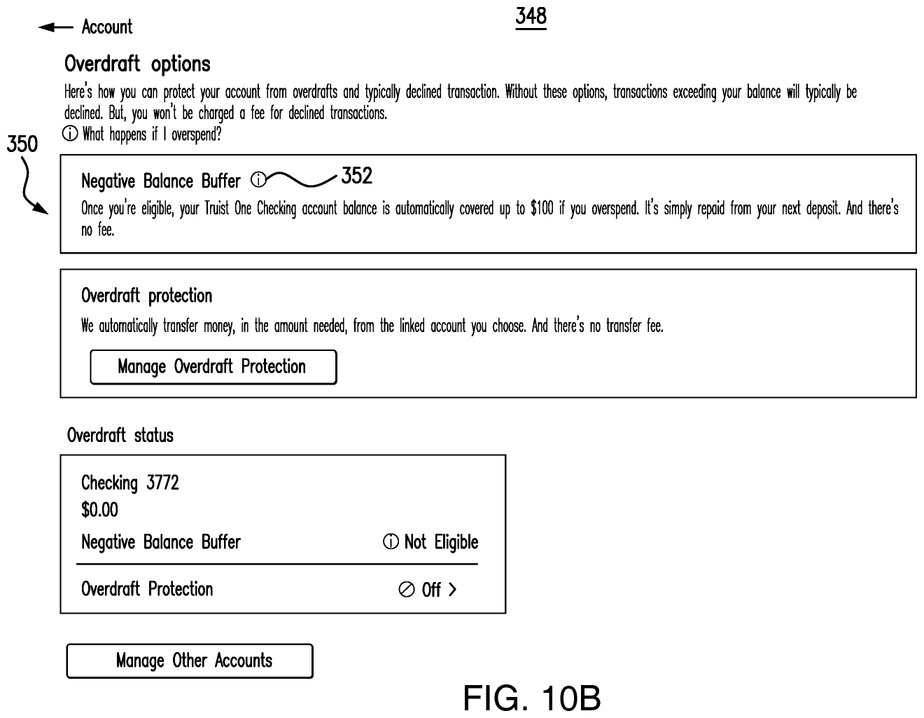

FIGS. 11A-11E show a mobile application (“app”) alternative to the GUI pages 301, 314, 322, 330, 336 (FIGS. 5-9), already discussed. In general, the plurality of status levels is spread across a corresponding plurality of scrollable pages of a GUI. More particularly, FIG. 11A shows a scrollable page 354 that includes an unlocked indicator 356 because a selected level 358 is below the current status level of the account in question. The scrollable page 354 also includes a description 355 of the selected level 358. Similarly, FIG. 11B shows a scrollable page 360 that includes the unlocked indicator 356 because a selected level 362 is below the current status level of the account in question. The scrollable page 360 also includes a description 361 of the selected level 362. Additionally, FIG. 11C shows a scrollable page 364 that includes a description 365 of a selected level 366 and the unlocked indicator 356 because the selected level 366 is below the current status level of the account in question and FIG. 11D shows a scrollable indicator 356 because the selected level 370 is below the current status level of the account in question. By contrast, FIG. 11E shows a scrollable page 372 that includes an indication 374 of the current status level and a description 373 of the current status level. Each of the scrollable pages 354, 360, 364, 368, 372 also includes an overdraft management option 376.

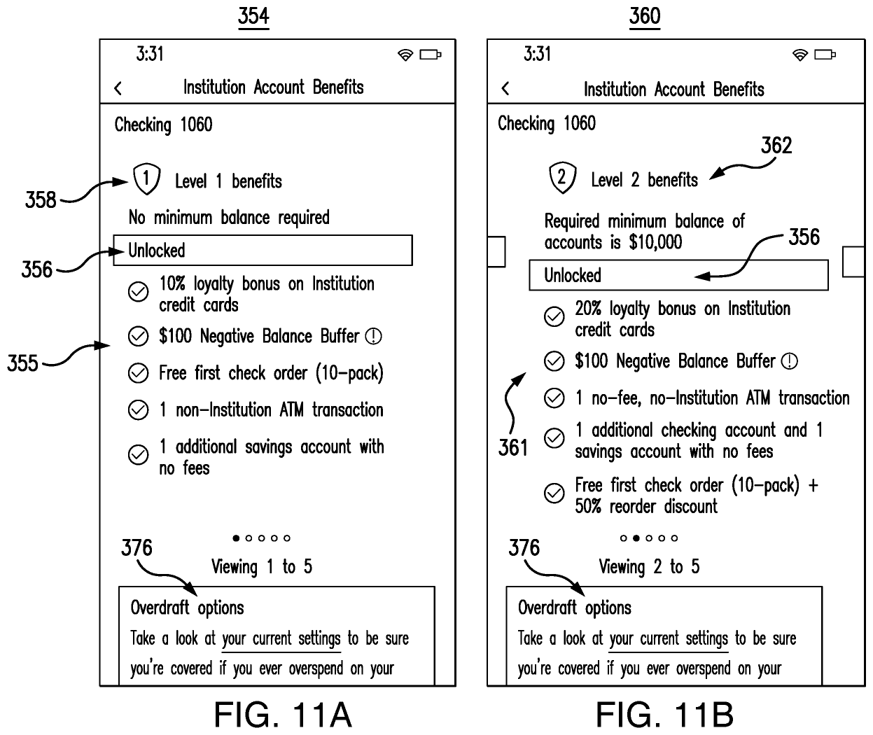

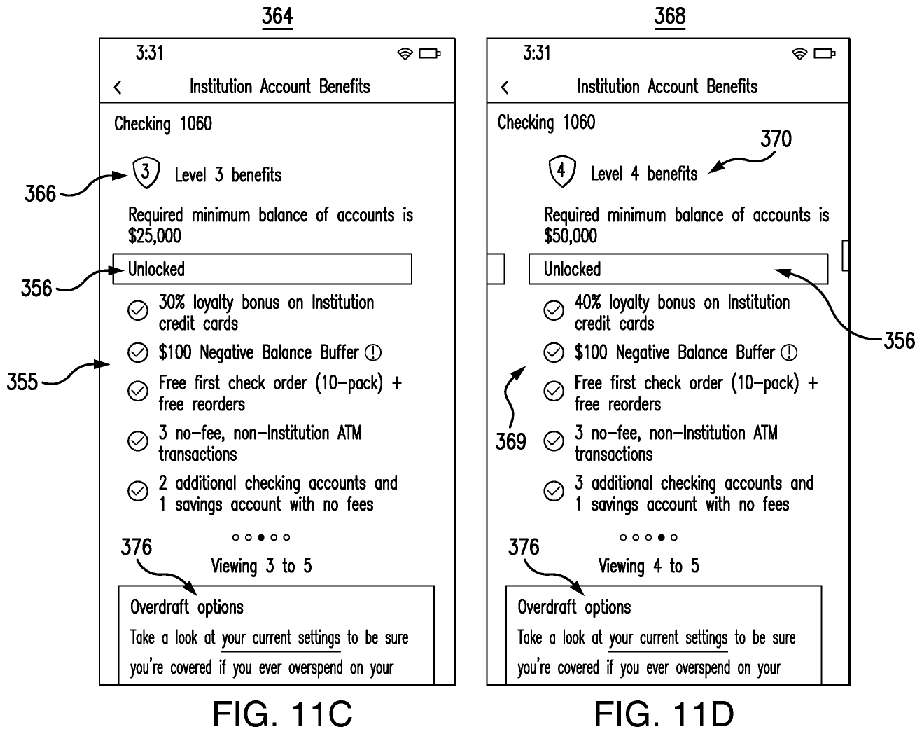

FIG. 12A shows a landing page 378 that may be presented when the overdraft management option 376 (FIGS. 11A-11E) is selected by the account owner. In the illustrated example, the landing page 378 indicates the overdraft status of the account in question and provides the ability to enroll in overdraft protection. In an embodiment, the landing page 378 also includes a description 380 of a negative balance buffer option. For example, when a direct deposit condition is detected with respect to the account, a negative balance will be permitted in response to the direct deposit condition, wherein the negative balance will be automatically repaid from a subsequent direct deposit. In one example, the direct deposit condition includes the account being open for certain amount of time (e.g., thirty-five days) and a direct deposit of a specified amount (e.g., at least 100USD) having been made for a minimum period of time (e.g., two consecutive months), and the account being in good standing. Thus, the description 380 of the negative balance buffer option further increases fee transparency and improves customer loyalty.

FIG. 12B shows a landing page 382 that may be presented to the account owner when a level up option 384 is selected from one of the scrollable pages 354, 360, 364, 368, 372 (FIGS. 11A-11E). In the illustrated example, the landing page 382 includes an explanation of how an aggregate balance is used to increase the status level of (e.g., level up) the account, as well as a transfer option 386 to initiate the level up.

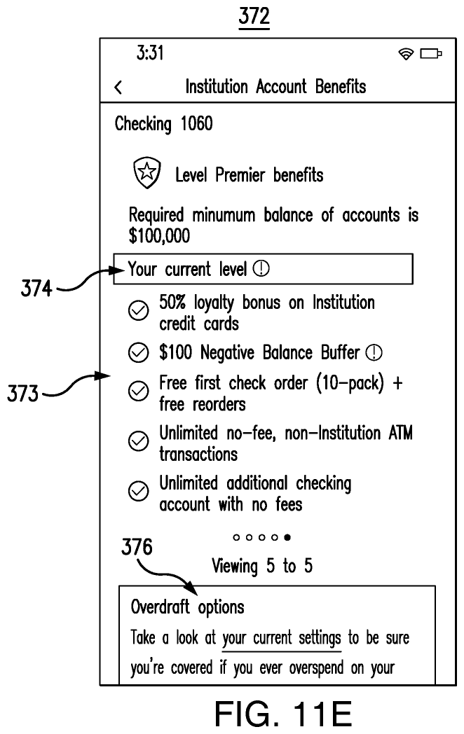

FIGS. 13A and 13B show a first state 388 and a second state 390 of a GUI page, respectively, when an increase in the current status level of the account is detected. In the first state 388 a confetti-based animation 392 is initialized with a check mark and in the second state 390 confetti is added to the confetti-based animation 394. The confetti-based animations 392, 394 therefore further improve customer loyalty by adding a game-like look and feel to the level up process.

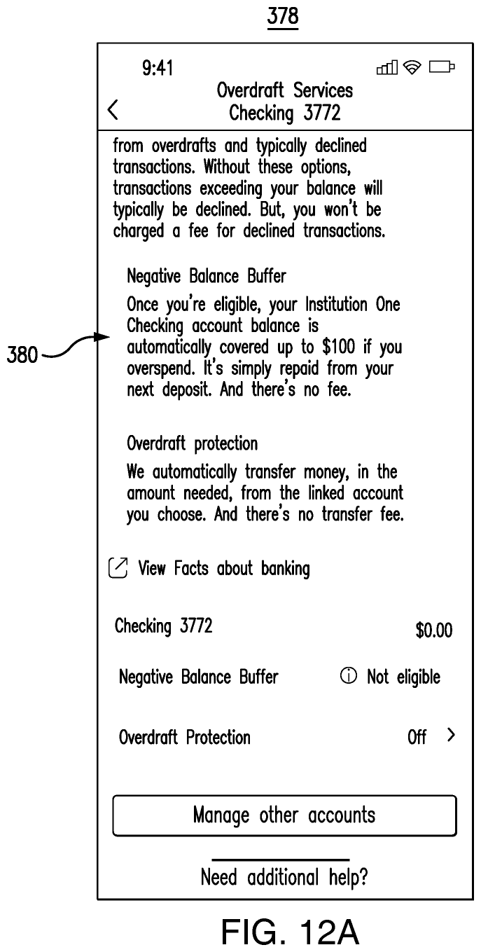

FIG. 14 shows a GUI page 396 for a mobile app alternative in which a confetti-based animation 398 is incorporated into the GUI page 396 in response to an increase of the current status level of the account. Again, the confetti-based animation 398 further improves customer loyalty by adding a game-like look and feel to the level up process.

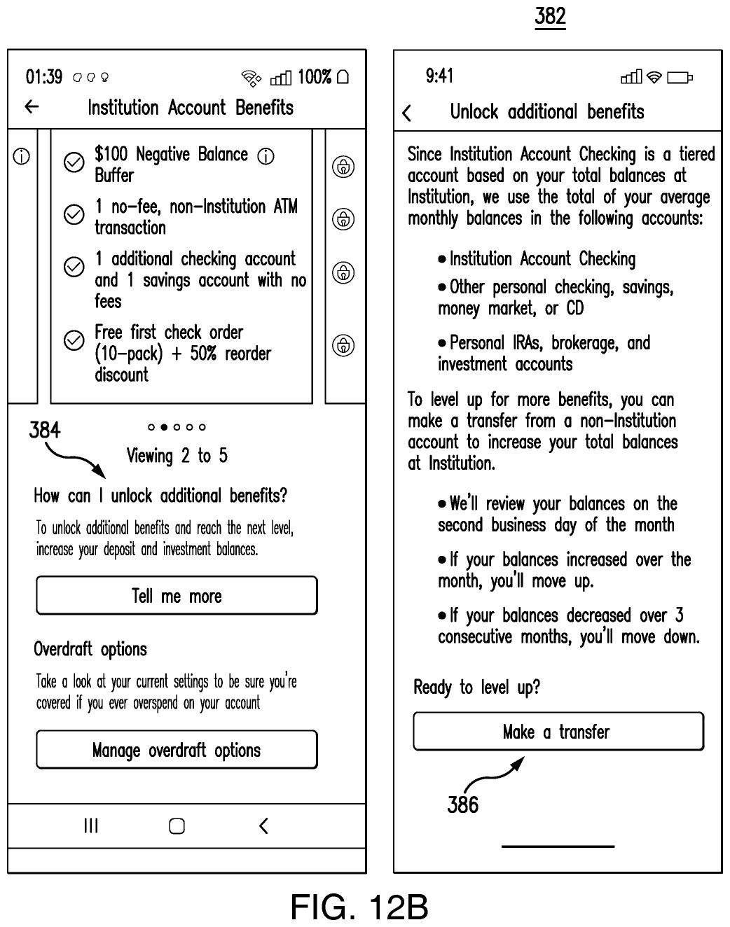

Turning now to FIG. 15, an alert preferences page 400 is shown. The illustrated alert preferences page 400 includes a level up alert option 402 and a level down alert option 404. Thus, the alert preferences page 400 enables the account owner to be notified when a change in the current status level of the account occurs.

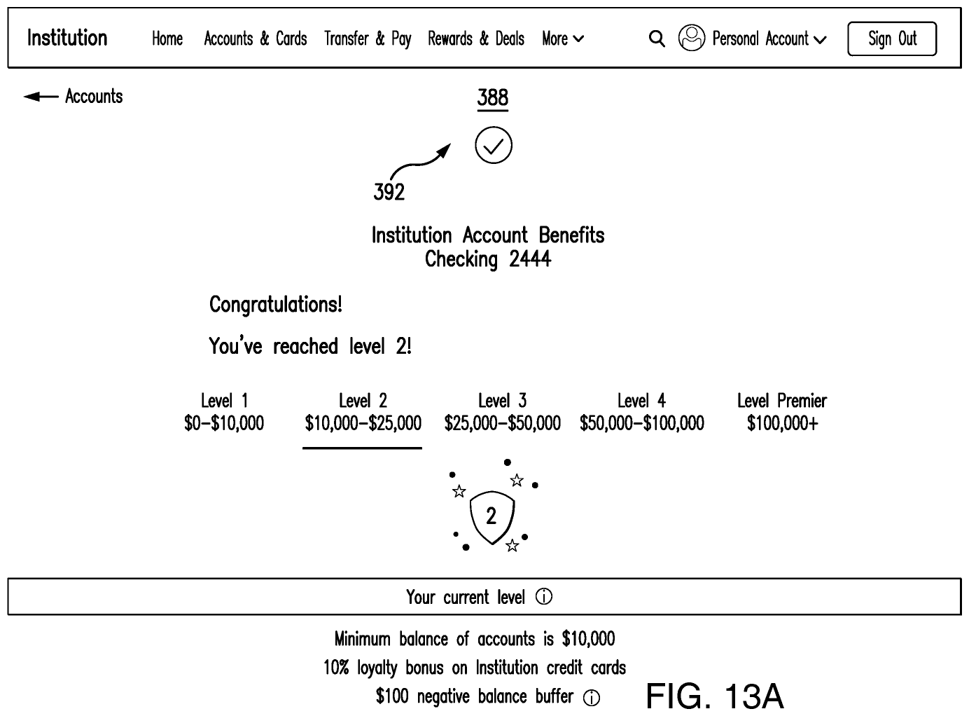

FIG. 16 shows a computer-implemented method 410 of operating a performance-enhanced computing system. The computer-implemented method 410 may generally be implemented in a server such as, for example, the financial institution server(s) 200 (FIGS. 1 and 4), already discussed. More particularly, the computer-implemented method 410 may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the computer-implemented method 410 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 412 identifies a current status level of an account based on an aggregate balance associated with an individual corresponding to the account. In one example, the account is a checking account and the aggregate balance is determined by summing the average monthly balance of the checking account with the average monthly balances of other personal checking, savings, money market, certificate of deposit (CD), personal individual retirement account (IRA), brokerage and/or investment accounts of the individual. Other types of accounts such as, for example, gaming accounts, frequent flyer mileage accounts, etc., may also be used (e.g., with the aggregate balance being points, miles, and so forth). Block 414 generates a GUI, wherein the GUI includes an indication of a plurality of status levels, an indication of the current status level, an unlocked indicator for status levels below the current status level, and a locked indicator for status levels above the current status level. In one embodiment (e.g., web browser), the indication of the plurality of status levels is contained within a single page of the GUI. In another embodiment (e.g., mobile app), the indication of the plurality of status levels is spread across a corresponding plurality of scrollable pages of the GUI. Additionally, the indication of the plurality of status levels may include a description of each of the plurality of status levels. Block 416 sends the GUI to a client device associated with the individual for display on a user interface of the client device. The computer-implemented method 410 therefore enhances performance at least to the extent that presenting the plurality status levels in the GUI pages enables the account owner to seamlessly determine the fee and benefit structure of each status level, as well as the requirements for gaining access to each status level. Moreover, incorporating the unlocked indicator and the locked indicator into the GUI page(s) makes the computing system more efficient in increasing customer loyalty.

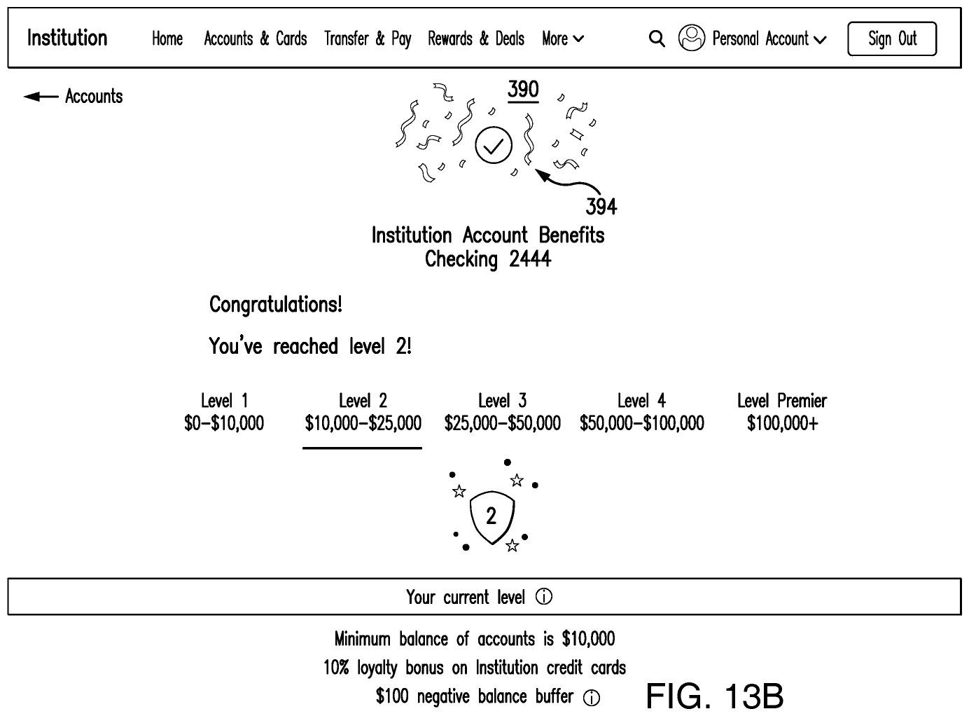

FIG. 17 shows a computer-implemented method 420 of handling a level up event. The computer-implemented method 420 may generally be implemented in a server such as, for example, the financial institution server(s) 200 (FIGS. 1 and 4), already discussed. Additionally, the computer-implemented method 420 may be readily incorporated into block 414 (FIG. 16), already discussed. More particularly, the computer-implemented method 420 may be implemented in one or more modules as a set of logic instructions stored in a machine- or computer-readable storage medium such as RAM, ROM, PROM, firmware, flash memory, etc., in hardware, or any combination thereof. For example, hardware implementations may include configurable logic, fixed-functionality logic, or any combination thereof.

Illustrated processing block 422 provides for detecting an increase in the current status level of an account. Block 422 may include monitoring and/or calculating the sum of the average monthly balance of a personal checking, savings, money market, CD, personal IRA, brokerage and/or investment accounts of an individual. Block 424 incorporates a confetti-based animation into the GUI in response to the increase in the current status level. The confetti-based animation therefore further improves customer loyalty by adding a game-like look and feel to the level up process.

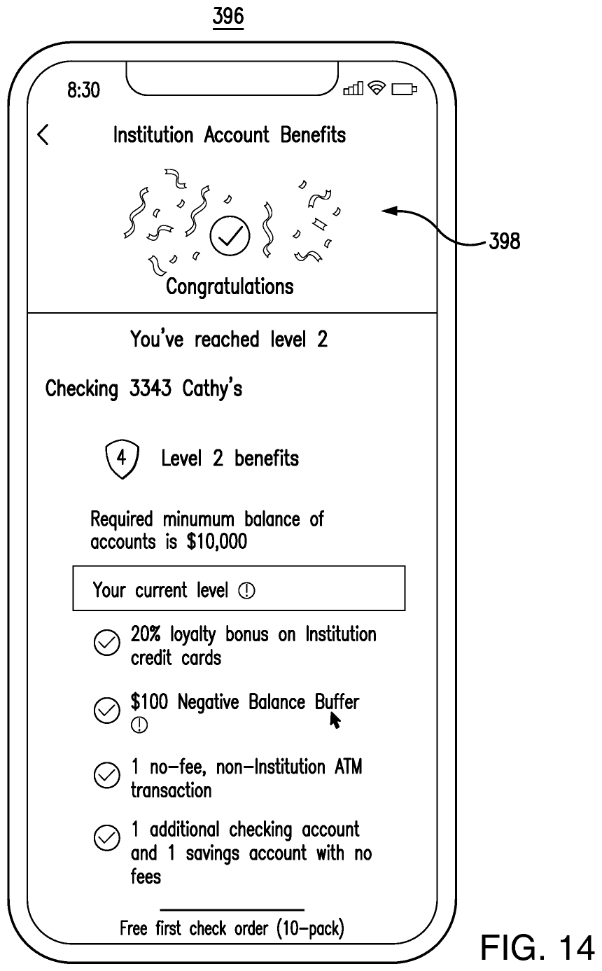

FIG. 18 shows a computer-implemented method 430 of generating a GUI. The computer-implemented method 430 may generally be implemented in a server such as, for example, the financial institution server(s) 200 (FIGS. 1 and 4), already discussed. Additionally, the computer-implemented method 430 may be readily incorporated into block 414 (FIG. 16), already discussed. More particularly, the computer-implemented method 430 may be implemented in one or more modules as a set of logic instructions stored in a machine- or computer-readable storage medium such as RAM, ROM, PROM, firmware, flash memory, etc., in hardware, or any combination thereof. For example, hardware implementations may include configurable logic, fixed-functionality logic, or any combination thereof.

Illustrated processing block 432 incorporates a level up option into the GUI. Additionally, block 434 incorporates an alert preferences page into the GUI, wherein the alert preferences page includes a level up alert option and a level down alert option. Thus, the alert preferences page enables the account owner to be notified when a change in the current status level of the account occurs.

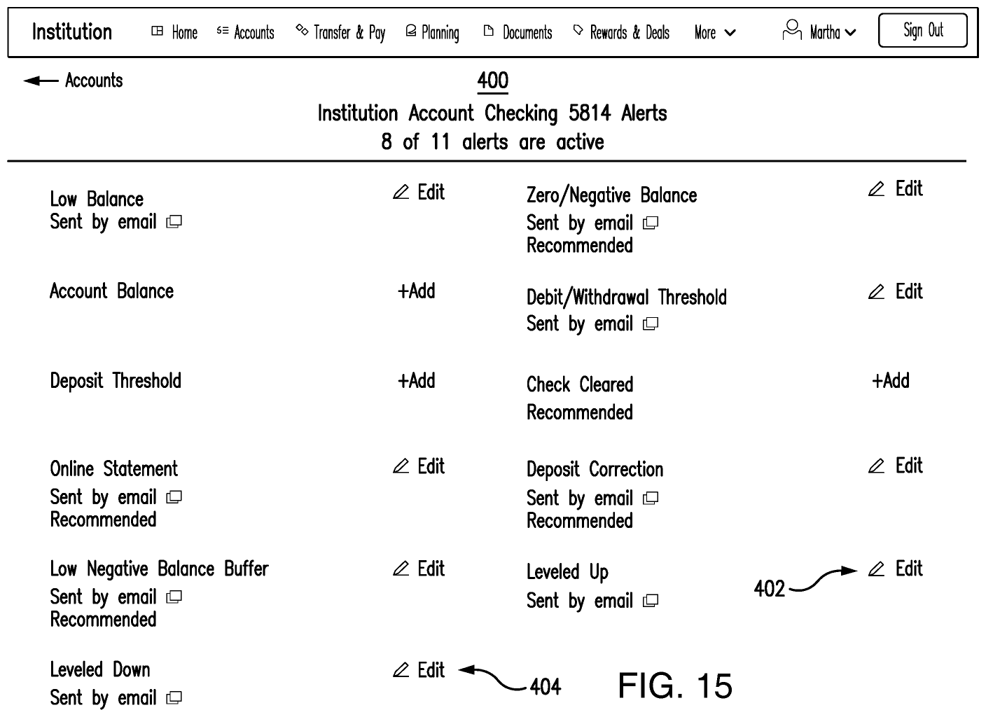

FIG. 19 shows a computer-implemented method 440 of handling a direct deposit condition. The computer-implemented method 440 may generally be implemented in a server such as, for example, the financial institution server(s) 200 (FIGS. 1 and 4), already discussed. More particularly, the computer-implemented method 440 may be implemented in one or more modules as a set of logic instructions stored in a machine- or computer-readable storage medium such as RAM, ROM, PROM, firmware, flash memory, etc., in hardware, or any combination thereof. For example, hardware implementations may include configurable logic, fixed-functionality logic, or any combination thereof.

Illustrated processing block 442 provides for detecting the direct deposit condition with respect to the account. In one example, the direct deposit condition includes the account being open for certain amount of time (e.g., thirty-five days) and a direct deposit of a specified amount (e.g., at least 100USD) having been made for a minimum period of time (e.g., two consecutive months), and the account being in good standing. Block 444 permits a negative balance in the account in response to the direct deposit condition. In an embodiment, block 444 includes approving one or more transactions that result in the negative balance and confirming that the negative balance has not exceeded a predetermined threshold (e.g., 100USD). Block 446 repays the negative balance from a subsequent direct deposit. The computer-implemented method 440 therefore reduces unexpected fees (e.g., overdraft fees) and significantly enhances customer loyalty.

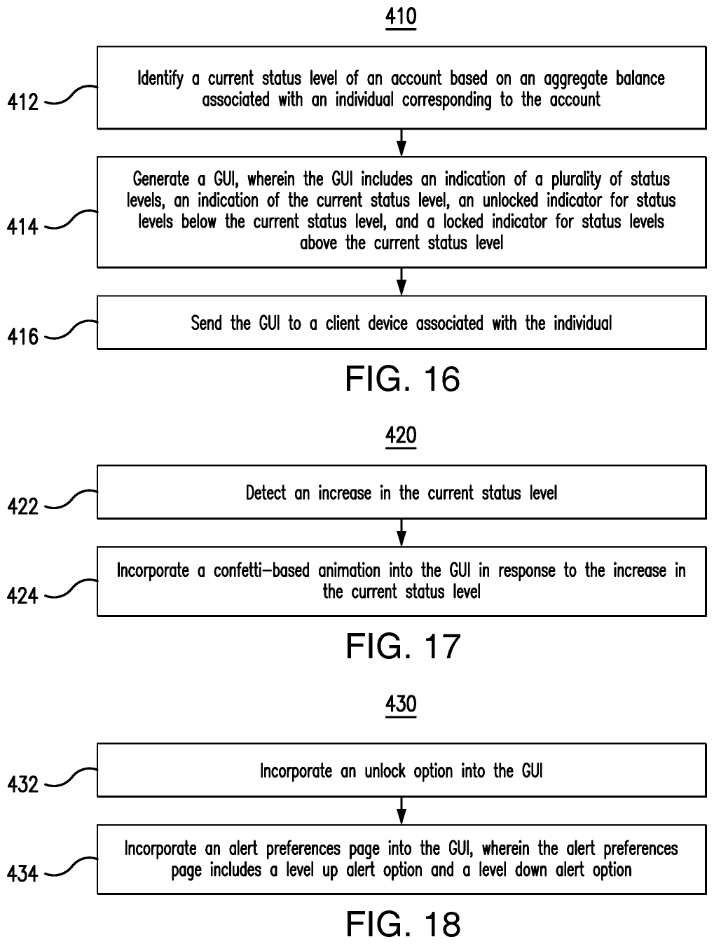

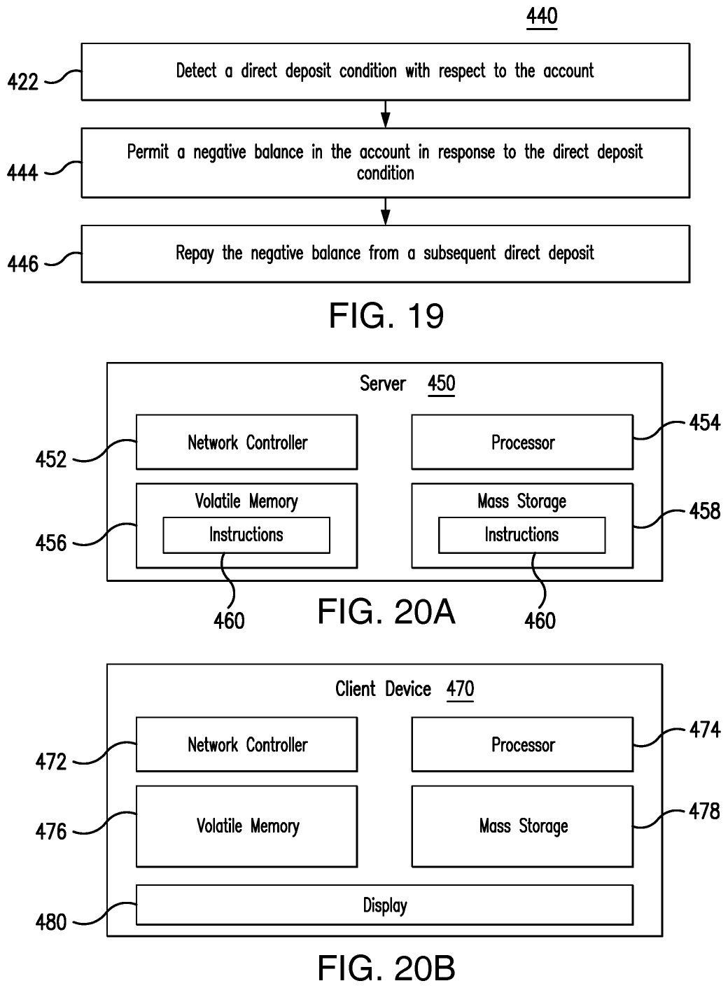

FIG. 20A shows a server 450 (e.g., computing system) that includes a network controller 452 (e.g., wired, wireless), a processor 454 (e.g., host processor, central processing unit/CPU), a volatile memory 456 (DRAM), and mass storage 458 (e.g., flash memory, optical disc, hard disk drive/HDD, solid state drive/SDD). In the illustrated example, the processor 454 executes instructions 460 retrieved from the volatile memory 456 and/or the mass storage 458 to conduct one or more aspects of the computer-implemented method 410 (FIG. 16), the computer-implemented method 420 (FIG. 17), the computer-implemented method 430 (FIG. 18) and/or the computer-implemented method 440 (FIG. 19), already discussed. Thus, execution of the instructions 460 causes the processor 454 to identify a current status level of an account based on an aggregate balance associated with an individual corresponding to the account and generate a GUI, wherein the GUI includes an indication of a plurality of status levels, an indication of the current status level, an unlocked indicator for status levels below the current status level, and a locked indicator for status levels above the current status level. Execution of the instructions 460 also causes the processor 454 to send, via the network controller 452, the GUI to a client device associated with the individual for display on a user interface of the client device.

The server 450 is therefore considered performance-enhanced at least to the extent that presenting the plurality status levels in the GUI pages enables the account owner to seamlessly determine the fee and benefit structure of each status level, as well as the requirements for gaining access to each status level. Moreover, incorporating the unlocked indicator and the locked indicator into the GUI page(s) makes the server 450 more efficient in increasing customer loyalty.

FIG. 20B shows a client device 470 (e.g., personal computer, mobile device) that includes a network controller 472 (e.g., wired, wireless), a processor 474 (e.g., host processor, CPU), volatile memory 476 (e.g., DRAM), mass storage 478 (e.g., flash memory, optical disc, HDD, SDD), and a display 480. In an embodiment, the network controller 472 receives a GUI generated in accordance with the computer-implemented method 410 (FIG. 16), the computer-implemented method 420 (FIG. 17), the computer-implemented method 430 (FIG. 18) and/or the computer-implemented method 440 (FIG. 19), already discussed, and the client device 470 presents the GUI on the display 480.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A computing system, comprising:
a network controller;
a processor coupled to the network controller; and
a memory coupled to the processor, wherein the memory includes a set of instructions, which when executed by the processor, cause the processor to:
identify a current status level of an account based on an aggregate balance associated with an individual corresponding to the account,
generate a graphical user interface (GUI), wherein the GUI includes an indication of a plurality of status levels, an indication of the current status level, an unlocked indicator for status levels below the current status level, and a locked indicator for status levels above the current status level, wherein the indication of the plurality of status levels includes a description of each of the plurality of status levels,
incorporate a level up option into the GUI,
incorporate an alert preferences page into the GUI, wherein the alert preferences page includes a level up alert option and a level down alert option,
detect an increase in the current status level,
incorporate a confetti-based animation into the GUI in response to the increase in the current status level, and
cause, via the network controller, display of the GUI on a user interface of a client device associated with the individual.

2. The computing system of claim 1, wherein the indication of the plurality of status levels is contained within a single page of the GUI.

3. The computing system of claim 1, wherein the indication of the plurality of status levels is spread across a corresponding plurality of scrollable pages of the GUI.

4. The computing system of claim 1, wherein the instructions, when executed, further cause the processor to:
detect a direct deposit condition with respect to the account,
permit a negative balance in the account in response to the direct deposit condition, and
repay the negative balance from a subsequent direct deposit.

5. A computing system, comprising:
a network controller;
a processor coupled to the network controller; and
a memory coupled to the processor, wherein the memory includes a set of instructions, which when executed by the processor, cause the processor to:
identify a current status level of an account based on an aggregate balance associated with an individual corresponding to the account,
generate a graphical user interface (GUI), wherein the GUI includes an indication of a plurality of status levels, an indication of the current status level, an unlocked indicator for status levels below the current status level, and a locked indicator for status levels above the current status level, and
cause, via the network controller, display of the GUI on a user interface of a client device associated with the individual.

6. The computing system of claim 5, wherein the instructions, when executed, further cause the processor to:
detect an increase in the current status level, and
incorporate a confetti-based animation into the GUI in response to the increase in the current status level.

7. The computing system of claim 5, wherein the instructions, when executed, further cause the processor to incorporate a level up option into the GUI.

8. The computing system of claim 5, wherein the instructions, when executed, further cause the processor to incorporate an alert preferences page into the GUI, wherein the alert preferences page includes a level up alert option and a level down alert option.

9. The computing system of claim 5, wherein the indication of the plurality of status levels includes a description of each of the plurality of status levels.

10. The computing system of claim 5, wherein the indication of the plurality of status levels is contained within a single page of the GUI.

11. The computing system of claim 5, wherein the indication of the plurality of status levels is spread across a corresponding plurality of scrollable pages of the GUI.

12. The computing system of claim 5, wherein the instructions, when executed, further cause the processor to:
detect a direct deposit condition with respect to the account,
permit a negative balance in the account in response to the direct deposit condition, and
repay the negative balance from a subsequent direct deposit.

13. At least one computer readable storage medium comprising a set of instructions, which when executed by a computing system, cause the computing system to:
identify a current status level of a financial account at a financial institution based on an aggregate balance associated with an individual corresponding to the financial account;
generate a graphical user interface (GUI), wherein the GUI includes an indication of a plurality of status levels, an indication of the current status level, an unlocked indicator for status levels below the current status level, and a locked indicator for status levels above the current status level; and
cause display of the GUI on a user interface of a client device associated with the individual.

14. The at least one computer readable storage medium of claim 13, wherein the instructions, when executed, further cause the computing system to:
detect an increase in the current status level; and
incorporate a confetti-based animation into the GUI in response to the increase in the current status level.

15. The at least one computer readable storage medium of claim 13, wherein the instructions, when executed, further cause the computing system to incorporate a level up option into the GUI.

16. The at least one computer readable storage medium of claim 13, wherein the instructions, when executed, further cause the computing system to incorporate an alert preferences page into the GUI, wherein the alert preferences page includes a level up alert option and a level down alert option.

17. The at least one computer readable storage medium of claim 13, wherein the indication of the plurality of status levels includes a description of each of the plurality of status levels.

18. The at least one computer readable storage medium of claim 13, wherein the indication of the plurality of status levels is contained within a single page of the GUI.

19. The at least one computer readable storage medium of claim 13, wherein the indication of the plurality of status levels is spread across a corresponding plurality of scrollable pages of the GUI.

20. The at least one computer readable storage medium of claim 13, wherein the instructions, when executed, further cause the computing system to:
detect a direct deposit condition with respect to the account;
permit a negative balance in the account in response to the direct deposit condition; and
repay the negative balance from a subsequent direct deposit.
